(19) United States
(12) Patent Application Publication
(10) Pub. No.: US 2003/0210958 A1
(43) Pub. Date: Nov. 13, 2003

(54) Method for laying cables, information network and operation of an information network

(75) Inventor: Klaus Nothofer, Erkrath (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/429,717

(22) Filed: May 6, 2003

(30) Foreign Application Priority Data
May 13, 2002 (EP) 02 360 148.7

(51) Int. Cl. F16L 11/00; B63B 35/03

(52) U.S. Cl. 405/154.1; 405/174; 138/121

(57) ABSTRACT

A laying method for cables, which consists of a conduit and electrical and/or optical information cables, which can be inserted in the latter, is proposed. The cables are laid in grooves of a laying foundation which follows the path of a switching network.

### BACKGROUND OF THE INVENTION

The invention is based on a priority application EP 02360148.7 which is hereby incorporated by reference.

The invention starts out from a method for laying cables consisting of a conduit and electrical and/or optical information cables, which can be inserted in the latter, in grooves of a laying foundation which follows the path of a switching network. The invention also starts out from an information network based on information cables which are laid along a switching network as laying foundation.

Methods for laying cables with optical and electrical information cables in grooves of firm laying foundations are known. These methods relate to the laying of cables in road routes. For example, German Pat. DE 197 15 213 describes a method for laying cables in which a conduit and optical information cables, which are loosely disposed therein, are laid in grooves of a firm laying foundation. The underlying problem consists in the risk of damaging an information system which has already been laid when laying cables in grooves. DE 197 15 213 therefore proposes laying cables along routes, with the cables of different information systems being fitted and routed at different laying levels. Although this reduces the risk of damage to the information system which has already been laid, it does not exclude this.

The known method does not offer a solution, especially in cases in which a large number of operators of information systems wish to lay their information cables.

### SUMMARY OF THE INVENTION

One proposal therefore lies in laying one or more empty conduits, consisting of steel, along the switching network. The use of steel conduits as an empty conduit along the switching network has the advantages of a high degree of stability and optimum protection against damage to the information cable which is to be fitted. Moreover, the steel sheath protects the pulled-in cables against effects of fire, which represents a risk along roads due to burning vehicles and leaking petrol following accidents.

A particularly advantageous and particularly stable measure lies in using a corrugated steel conduit which, due to its geometric shape, has high lateral and compressive stability. This also provides special protection for the cable against deformation of the surface of the laying foundation, as results, for example, due to frost or summer heat.

Further advantages of the corrugated steel conduit lie in the fact that it can be easily bent and the open ends can be closed by screwing in adapted corrugated plugs. The steel conduit is advantageously provided with couplings, in which case building and housing complexes can be connected to the information network via these couplings.

The method according to the invention has the advantage of providing easy insertion of information cables for the first time and of further information cables by pulling, blowing or pushing them in once the empty conduit infrastructure has been laid. The possibility of additionally inserting further information cables permits a high degree of freedom in the additional extension of cable networks by suppliers of further services. An information network of this kind, which is based on laid steel conduits, can be implemented without a high expenditure. Further building connections may be installed by integrating couplings as new branches.

Advantageous constructions and solutions are represented in the following figures and illustrated in detail in the description.

### BRIEF DESCRIPTION OF THE DRAWINGS

FIG. 1 shows an installation of empty conduits.

FIG. 2 is a cross section of a road surface with empty conduit.

FIG. 3 shows steps of the laying method.

FIG. 4 shows the mounting of the empty conduits in the groove.

FIG. 5 shows a further mounting in the groove.

FIG. 6 shows a selected steel conduit with adopted plastics plug.

### DETAILED DESCRIPTION OF THE DRAWINGS

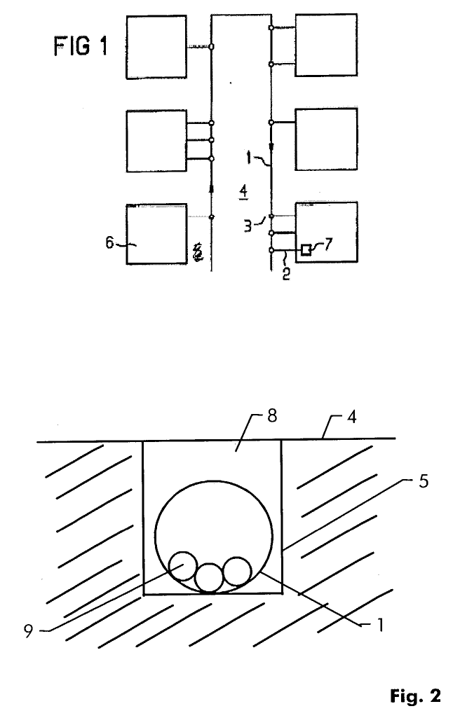

FIG. 1 is a plan view showing a network of empty conduits which are inserted in a laying foundation. The route of the steel conduits follows a road 4. In this example the empty conduits are laid along the kerbs. The empty conduits 1 comprise couplings 3, via which branches 2 lead to the adjacent blocks of houses 6. Subscribers' connections 7, at which the empty conduits end, are provided in the houses. In this example the conduits are laid along the kerbs. It is also advantageous to lay the conduits along pavements or along the centre of the road.

FIG. 2 is a cross section of a laid empty conduit 1. The empty conduit is fitted in a groove 5 in the road 4. The empty conduit contains, for example, three information cables 9. The empty conduit 1 is covered by filling material 8.

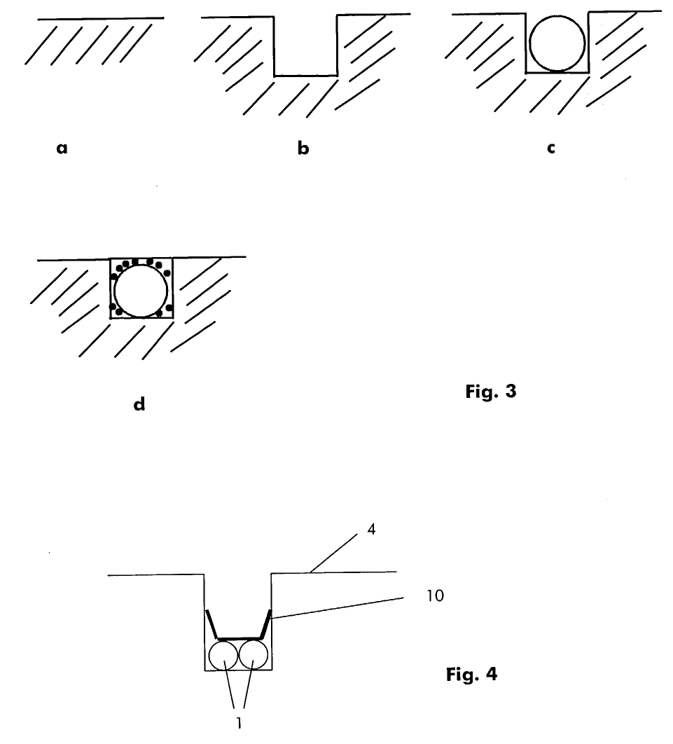

FIG. 3 shows in diagrammatic form the method for laying the empty conduit. Beginning from a normal road or pavement surface, a groove 5 is milled in the surface using a conventional milling cutter. The empty conduit 1 is fitted in the milled groove 5. The groove is filled with filling material after fitting the empty conduit. The filling material which is used in this case is an elastic material such as bituminous concrete or an epoxy resin. Another suitable filling material is described in the German Pat. 197 26 880, this being a filling compound with a water-repellant and sealing base material as well as a granular material, which is admixed to obtain the flexible properties. The function of the filling compound is to protect the empty conduit against mechanical influences, although it must be elastic enough not to transmit compressive loads directly to the empty conduit. The method which is represented in a basic form in FIG. 3 is improved if the milled groove is cleaned before the empty conduit is laid. The removal of loose stone particles makes it easier to lay the empty conduits. The groove is exhausted or swept out for this purpose.

It is also of advantage to fix the empty conduit with clamps or clips before the filling operation with elastic filling material.

FIG. 4 shows in diagrammatic form two fitted empty conduits 1, fixed by a clip 10. The use of mountings enables the empty conduit to be fixed before the groove is sealed. This measure ensures that the empty conduit remains at its stipulated location in the groove during the laying work and before sealing.

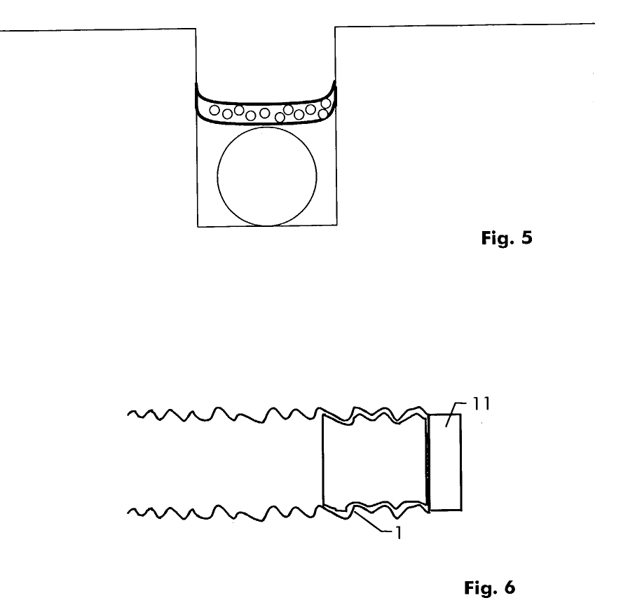

FIG. 5 represents a further advantageous embodiment of the laying system. This shows the example of a continuous covering of the empty conduit with an elastic strip of a foamed plastics material. The empty conduit is fixed and at the same time elastically embedded in the groove by installing an empty conduit below a foam strip.

FIG. 6 shows an advantageous embodiment of the empty conduit. A corrugated steel conduit has a particularly high level of stability while at the same time having excellent bending properties. A corrugated steel conduit additionally has the advantage of enabling the open ends to be easily closed by a plastics plug which is likewise structured. A plug 11 of this kind is in this case screwed in at the open end of the corrugated steel conduit.

It is equally easy to install branches, for which couplings are screwed into the corrugated steel conduit in a comparable manner. The connections to building blocks or individual buildings are laid by way of the branches. Empty conduits can in this respect already be laid into the building interior at a house connection. For this purpose the building walls are bored through with a conventional boring implement and the steel conduit laid as an empty conduit. It is even easy to subsequently install a branch when using an empty steel conduit.

A suitable opening is cut into the steel conduit, to which opening a coupling is suitably secured. In order to avoid having to subsequently open the empty conduit, it is possible to build up an installation network in which branches already having mounted couplings are provided at regular intervals. These branches may initially end in “nothing”. It is then easy to continue distributing information cables from these distribution points. Once the steel conduits have been installed as empty conduits along a switching network, the first installation of the information cables may take place.

Known laying methods such as blowing cables into empty conduits are used here. It is of advantage to lay an empty conduit with a fitted draw thread in order to make the first installation easier. If a plurality of draw threads are already laid in a system of empty conduits, it will be easier to subsequently install additional information cables. The type of cable which can be laid is not limited when using the empty steel conduit. The empty steel conduit is sufficiently protected against compressive and thermal loads. It also protects the inserted cables against the effects of water. Furthermore, the steel conduit has sufficiently good electrical properties to minimise disturbances here as well. The steel conduit is at the same time a shield for cables with electrical leakages.

1. Cable layout, consisting of a conduit system, which is laid along a switching network as laying foundation, and cables laid therein, characterised in that the cable conduits are constructed as corrugated steel conduits, and that one or more cable conduits are fitted in grooves which are located at the surface of the laying foundation, wherein the groove depth is smaller than the useful layer of the laying foundation, and the grooves with the enclosed cable conduits are filled with a sealing compound.

2. Method for laying cables according to claim 1, consisting of a conduit layout and electrical and/or optical information cables, which can be inserted in the latter, comprising the following steps:
milling or sawing grooves in the laying foundation
laying an empty conduit or a plurality of steel conduits in the groove filling the groove with a sealing compound.

3. Method according to claim 2, comprising the additional steps of:
cleaning the groove in the laying foundation
fixing the empty conduits with fixing means.

4. Method according to claim 2, wherein open ends of the empty conduits are closed by plugs.

5. Method according to claim 4, wherein the plugs are formed like screws at one end such that they can be screwed into the corrugated steel conduit.

6. Method according to claim 4, wherein buildings are connected by branches.

7. Method according to claim 2, wherein the information cables are inserted by pulling, blowing or pushing them in.

8. Operation of an information network according to claim 1.

9. Method according to claim 6, wherein the branches are formed by connection pieces which connect together two or more steel corrugated conduits of the same or different diameter.

10. Method according to claim 9, wherein the connections are constructed as screwed connections.

11. Method according to claim 9, wherein the connections are constructed as clamped connections.

12. Cable conduit according to claim 1, wherein the corrugated steel conduit consists of special steel of the series V2A or V4A.

13. Method according to claim 2, wherein the sealing compound consists of bitumen.

14. Method according to claim 2, wherein the sealing compound is asphalt.

15. Method according to claim 2, wherein the sealing compound is concrete.

16. Method according to claim 2, wherein the sealing compound is an epoxy resin.
